(19) United States
(12) Patent Application Publication
(10) Pub. No.: US 2018/0272821 A1
(43) Pub. Date: Sep. 27, 2018

(54) SPRING SUPPORT FOR A COIL SPRING

(71) Applicant: BASF SE, Ludwigshafen am Rhein (DE)

(72) Inventor: Waldemar MEIER, Lemfoerde (DE)

(73) Assignee: BASF SE, Ludwigshafen am Rhein (DE)

(21) Appl. No.: 15/781,504

(22) PCT Filed: Nov. 30, 2016
(86) PCT No.: PCT/EP2016/079202

§ 371 Date: Jun. 5, 2018

(30) Foreign Application Priority Data
Dec. 10, 2015 (DE) 10 2015 224 915.8

(51) Int. Cl. B60G 11/16; F16F 1/12

(52) U.S. Cl. CPC B60G 11/16; F16F 1/126; B60G 2204/12422; F16F 1/125; F16F 1/122

(57) ABSTRACT

The invention relates to a spring support for a coil spring (15), comprising an annular receiving element (5) having a top side and a bottom side, wherein the top side is provided to receive one end of the coil spring (15), and comprising an annular damping element (3), which is in contact with the bottom side of the receiving element (5), wherein the damping element (3) furthermore has on its inside a collar which extends from the bottom side of the receiving element (5) in the direction of the coil spring (15), and wherein the collar is formed by bending from a disk-shaped basic form of the damping element (3). The invention furthermore relates to a method for producing a spring support according to the invention, in which a disk-shaped damping element (3) is first of all placed in a casting mold, and an annular receiving element (5) is then produced by being molded or injection-molded to the damping element (3), with the result that the bottom side of the receiving element (5) is in contact with the annular damping element (3).

The present invention relates to a spring support for a coil spring, comprising an annular receiving element having a top side and a bottom side, wherein the top side is provided to receive one end of the coil spring, and comprising an annular damping element, which is in contact with the bottom side of the receiving element.

Spring supports of the type in question are used within the running gear in motor vehicles, among other applications, and are widely known. They are used within a wheel suspension system to hold a coil spring in the intended position between the body of the vehicle and the running gear components thereof. Apart from fixing the coil spring, spring supports generally also assume the task of damping or decoupling oscillations caused by driving over more or less rough road surfaces. At the same time, it should also be ensured that the coil spring and the body parts do not come into direct contact. In interaction with other running gear components, they are of great significance in the tuning of the vehicle in respect of ride comfort and driving safety.

Different types of spring supports are known, both in respect of their design configuration and in respect of their damping properties. Thus, document EP 0 778 166 A1 discloses a spring support in which a surface-forming damping element is provided on the side facing away from the spring in order to decouple oscillations from the body. In contrast, German Laid-Open Application DE 10 2005 049 747 A1 describes a spring support in which the oscillation-damping component is situated on the side facing the coil spring, so that the coil spring is supported thereon. U.S. Pat. No. 5,918,812 A discloses a sprinkler system in which star-shaped damping elements are incorporated, which damping elements are however not bent, in order to improve the damping properties of the damping, in particular in the radial direction. Further damping elements, which however do not have the advantageously bent collar, are disclosed in DE 696 12 080 T2, DE 10 2009 056 351 A1 and EP 0 036 994 A2.

Common to the abovementioned concepts of spring supports is that they have a primarily axial damping effect in respect of the alignment of the coil spring. Radial or lateral movements of the coil spring are allowed for only inadequately.

The object is to provide spring supports having improved damping properties, especially in respect of radial oscillation components of the coil spring.

This object has been achieved by means of spring supports according to the invention of the kind indicated in claim 1 and claim 4. Dependent claims 2 and 3 and 5 to 7 are directed to further advantageous embodiments of the invention. This object is furthermore achieved by methods for producing spring supports according to the invention of the kind indicated in claims 8 to 10.

In a first embodiment according to the invention, the spring support for a coil spring comprises an annular receiving element having a top side and a bottom side, wherein the top side is provided to receive one end of the coil spring. The spring support furthermore comprises an annular damping element, which is in contact with the bottom side of the receiving element. According to the invention, the damping element has on its inside a collar which extends from the bottom side of the receiving element in the direction of the coil spring. This collar is formed by bending from a disk-shaped basic form of the damping element.

The spring support according to the invention is preferably part of an automobile running gear or part of the cabin suspension in a mobile apparatus or part of a suspension for a moving part, which is preferably a motor.

The invention furthermore relates to a method for producing a spring support in accordance with the embodiment explained above. In a first step, a disk-shaped damping element is placed in a casting mold. In a next step, an annular receiving element is produced by being molded or injection-molded to the damping element, with the result that the bottom side of the receiving element is in contact with the annular damping element.

In another method according to the invention, a disk-shaped damping element is placed in a casting mold in a first step. The casting mold has a core, with the result that the inside of the damping element is bent over along the core, and the damping element adopts an annular form with a collar on its inside. In a next step, an annular receiving element is produced by being molded or injection-molded to the damping element, with the result that the bottom side of the receiving element is in contact with the annular damping element.

Contact between the damping element and the receiving element can also be brought about in some other way, e.g. by adhesive bonding or welding of the components. Production of the connection between the damping element and the receiving element during the production of the receiving element in accordance with the methods explained above is preferred, especially if the materials of the damping element and the receiving element can be connected directly by molding on or injection-molding on.

In a preferred embodiment of the spring support according to the invention, the disk-shaped basic form of the damping element has star-shaped notches on the inside thereof. This makes it easier to bend over the sections between the notches. The number of notches and the shape and dimensioning thereof are selected individually to meet the specific requirements. There are preferably five to twenty notches in the damping element. The notches can be configured in accordance with requirements, e.g. symmetrically or asymmetrically, concentrically or eccentrically, depending on the specific requirements, e.g. based on the installation space for the spring support.

The receiving-element top side provided to receive the end of the coil spring is preferably matched to the shape of the end of the coil spring, this end being a closed end or an end which runs out tangentially, for example.

The receiving element can be manufactured from different materials. A thermoplastic can preferably be used to produce it. Materials based on thermoplastic polyurethane (TPU), polyethylene (PE) or polypropylene (PP) have proven particularly suitable, especially owing to their material properties in respect of stiffness and flexibility.

Depending on the specific requirements on the spring support, e.g. in respect of the specified possibilities for fastening on the body or on running gear components, it may be necessary or advantageous to supplement the spring support with a further component.

In an advantageous development of the invention, the spring support furthermore comprises a bottom element that has an annular portion and a tubular portion. The annular portion of the bottom element is in contact with that side of the damping element which faces away from the coil spring, while the tubular portion extends through the damping element in the direction of the coil spring. The collar of the damping element rests on the outer lateral surface of the tubular portion.

Spring supports of this kind can be produced in various ways. A method is preferred in which the disk-shaped damping element is placed on the bottom element, and the receiving element is placed on the damping element, and the receiving element is then pressed in the direction of the bottom element, with the result that the damping element is fixed between the two other elements.

In another embodiment according to the invention, the spring support for a coil spring comprises an annular receiving element having a top side and a bottom side, wherein the top side is provided to receive one end of the coil spring, and comprises a disk-shaped damping element, which is in contact with the bottom side of the receiving element. The damping element has star-shaped notches on the inside thereof.

It is furthermore preferred that the receiving element have on its top side at least one clamping element for receiving one end of the coil spring. A plurality of individual clamping elements can be provided, but the at least one clamping element can also be configured so as to run around in a continuous manner. In a particularly advantageous embodiment, there are two clamping elements running around in a continuous manner, wherein one is provided on the side of the receiving element which is on the outside in the radial direction and the other is provided on the inner side in the radial direction. In particular, these two clamping elements are configured in such a way that they form a cavity with an opening through which the end of the helical spring can be pressed into the cavity. This embodiment of the clamping elements has the advantage, on the one hand, that the end of the coil spring is held reliably and, on the other hand, that the surface of the coil spring is protected in the surrounded area against damaging environmental influences, such as water or stone impact, by the large-area overlap.

In another preferred embodiment, the receiving element has on its top side at least one sealing element, which extends radially inward from the receptacle for the coil spring. The sealing element is preferably dimensioned in such a way that it rests in full surface contact on a part of the installation space provided for this purpose, e.g. the body of the vehicle, in the installed state, and thus protects the damping element situated underneath it from damaging environmental influences.

It is furthermore preferred that the receiving element have on its bottom side at least one sealing element which extends radially outward, downward or both outward and downward, starting from the lower outer edge of the main body of the receiving element 5. The sealing element is preferably dimensioned in such a way that it rests in full surface contact on the support surface of the spring mount, e.g. the body of the vehicle, in the installed state, and thus protects the damping element from damaging environmental influences.

As a particularly preferred option, the receiving element has a sealing element both on its top side and on its bottom side.

The damping element can be based on known materials, such as rubber or polyisocyanate-polyaddition products.

In a preferred embodiment, the damping element is based on elastomers on the basis of cellular polyisocyanate-polyaddition products, particularly preferably on the basis of cellular polyurethane elastomers, which may contain polyurea structures. Cellular means that the cells preferably have a diameter of 0.01 mm to 0.5 mm, particularly preferably 0.01 mm to 0.15 mm.

As a particularly preferred option, the polyisocyanate-polyaddition products have at least one of the following material properties: a density of between 270 and 900 kg/m³ according to DIN EN ISO 845, a tensile strength of ≥2.0 N/mm² according to DIN EN ISO 1798, an elongation at break of ≥200% according to DIN EN ISO 1798 or a tear propagation resistance of ≥8 N/mm according to DIN ISO 34-1 B (b). In further preferred embodiments, a polyisocyanate-polyaddition product has two of these material properties, as a further preference three of these material properties, and particularly preferred embodiments have all four of said material properties.

Elastomers on the basis of polyisocyanate-polyaddition products and the production thereof are well known and described in many places, e.g. in EP 62 835 A1, EP 36 994 A2, EP 250 969 A1, EP 1 171 515 A1, DE 195 48 770 A1 and DE 195 48 771 A1.

The disk-shaped damping element can be produced in various ways. A method in which a block or tube is first of all produced and then disks are cut from this block or tube is preferred. This allows efficient and low-cost manufacture of the damping elements.

A method in which a tube that already has the star-shaped aperture on the inside thereof is first of all produced is particularly preferred for the production of the disk-shaped damping element. Disks are then cut from this tube. When cellular polyisocyanate-polyaddition products are used as a material for the damping element, an internal core is preferably provided in the mold for producing the foamed tube, corresponding to the negative of the star-shaped notches.

As compared with spring supports known from the prior art, the spring supports according to the invention have the advantage that radial or lateral movements of the coil spring are also damped reliably or completely decoupled. This contributes to a reduction in noise transmission to the body and increases ride comfort. As compared with prior-art spring supports, in which the coil spring is in direct contact with the damping element and produces a point load or a linear load on the damping element, the spring support according to the invention has the advantage that a—substantially uniform—surface load is transmitted to the damping element by means of the receiving element. Premature localized damage to the damping element is thereby prevented. Moreover, the spring supports according to the invention are distinguished by the fact that they can be manufactured in a simple and low-cost manner.

### EXAMPLE

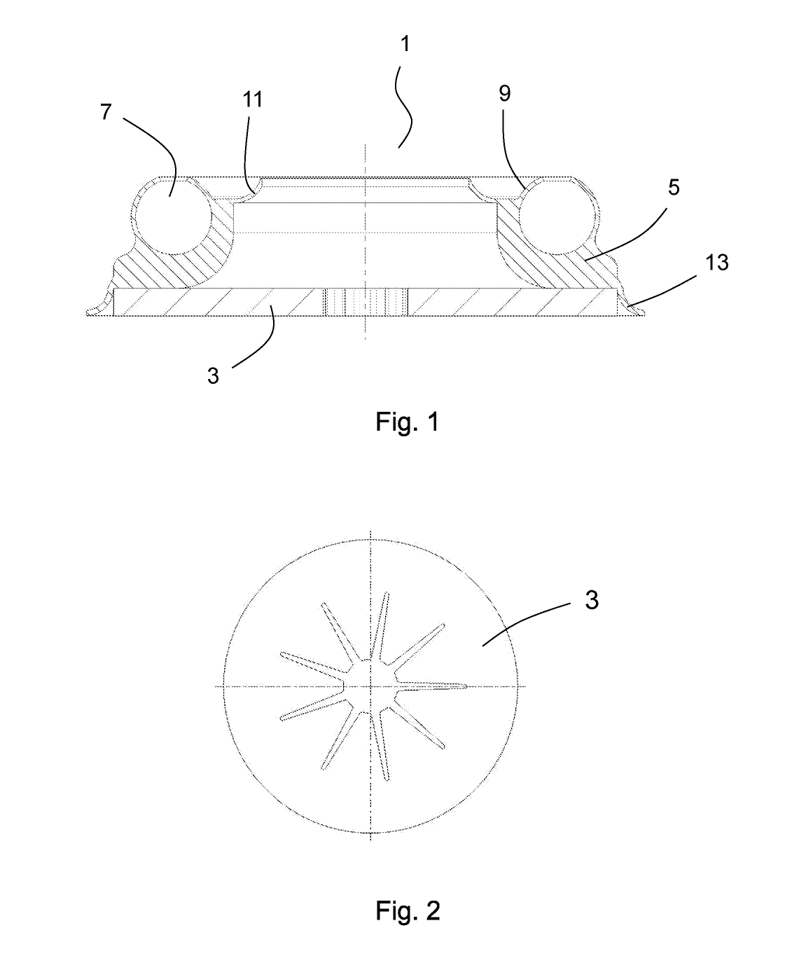

An embodiment of a spring support 1 according to the invention is shown in longitudinal section in FIG. 1. In this example, the component is configured so as to be rotationally symmetrical about the axis, indicated in chain-dotted lines. The spring support 1 comprises an annular receiving element 5 on the basis of a thermoplastic. In one embodiment, a material on the basis of a thermoplastic polyurethane (trade name “Elastollan®” made by BASF Polyurethanes GmbH, Lemforde) was used while, in another embodiment, a material on the basis of polyethylene was used. The receiving element 5 has a top side and a bottom side. The top side is provided to receive one end of a coil spring. In this example, the region 7 provided to receive the spring is configured as an annular cavity formed by clamping elements 9. The clamping elements 9 are connected integrally to the main body of the receiving element 5 and, at their upper end, have a gap through which the coil spring can be pushed into the cavity 7.

The bottom side of the receiving element 5 is in contact with a disk-shaped damping element 3, which has star-shaped notches on the inside thereof. The damping element 3 was produced by first of all foaming a tube made of cellular polyisocyanate-polyaddition product (trade name “Cellasto®” made by BASF Polyurethanes GmbH, Lemförde), in which there was a star-shaped core in the interior of the mold, with the result that the tube removed from the mold already had star-shaped notches. The tube was clamped onto a lathe and a single damping element 3 was cut from the clamped tube. The single damping element 3 is shown in plan view in FIG. 2. The star-shaped notches comprise a concentric aperture and nine uniformly spaced slots extending from it in a radial direction to the edge. The disk-shaped damping element 3 was placed in a casting mold, and then the receiving element shown was produced by injection molding onto the damping element 3.

The receiving element 5 furthermore comprises an encircling sealing element 11 on the top side thereof, which extends radially inward from the region 7 provided to receive the coil spring. The receiving element 5 furthermore comprises a sealing element 13 on the bottom side thereof, which extends radially outward and downward, starting from the lower outer edge of the main body of the receiving element 5.

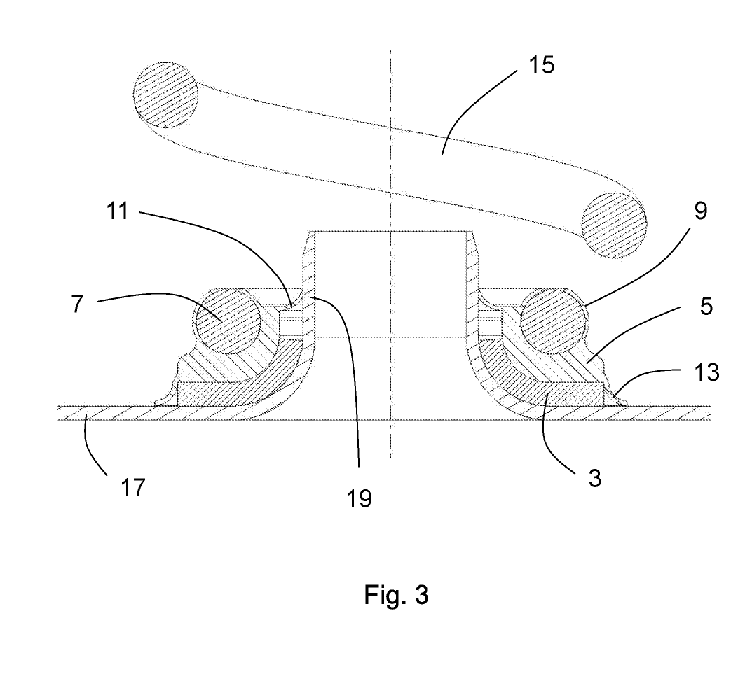

FIG. 3 shows the embodiment according to the invention, shown in FIG. 1, in the installed state. The spring support is mounted on a region of the body 17 of a vehicle which has a tubular extension 19. For mounting, the spring support was pressed onto the extension 19, thereby bending the originally disk-shaped damping element 3 into a collar which extends in the direction of the coil spring 15 from the bottom side of the receiving element 5. A coil spring 15 with a closed end was inserted by said end into the cavity 7 provided for reception in the receiving element 5 and was secured by the clamping elements 9, which surround the last spring turn over a wide area.

The sealing element 11 on the top side of the receiving element 5 is dimensioned in such a way that it rests over its full area circumferentially on the extension 19 of the body in the installed state. The sealing element 13 on the bottom side of the receiving element 5 is dimensioned in such a way that it rests over its full area circumferentially on the surface of the body 17 in the installed state. The two sealing elements 11 and 13 have the effect that the damping element 3 is protected from external influences, such as moisture and dirt, thereby extending the functioning capacity and service life thereof.

During the movement of the vehicle, the coil spring 15 is subjected both to axial loads and radial or lateral loads and excited into oscillations. All oscillation components are damped by the spring support according to the invention, thereby ensuring better damping behavior as compared with the prior art.

1. A spring support for a coil spring, the spring support comprising:
an annular receiving element having a top side and a bottom side, wherein the top side is provided to receive one end of the coil spring;
an annular damping element, which is in contact with the bottom side of the receiving element, wherein the damping element furthermore has on its inside a collar which extends from the bottom side of the receiving element in the direction of the coil spring, and wherein the collar is formed by bending from a disk-shaped basic form of the damping element.

2. The spring support as claimed in claim 1, wherein the disk-shaped basic form of the damping element has star-shaped notches on the inside thereof.

3. The spring support as claimed in claim 1, further comprising:
a bottom element that has an annular portion and a tubular portion, wherein the annular portion of the bottom element is in contact with that side of the damping element which faces away from the coil spring, the tubular portion extends through the damping element in the direction of the coil spring, and the collar of the damping element rests on the outer lateral surface of the tubular portion.

4. The spring support as claimed in claim 1, wherein the receiving element has on its top side at least one clamping element for receiving one end of the coil spring.

5. The spring support as claimed in claim 1, wherein the receiving element has on its top side at least one sealing element, which extends radially inward from the receptacle for the coil spring.

6. The spring support as claimed in claim 1, wherein the damping element is based on a cellular polyisocyanate-polyaddition product.

7. A method for producing a spring support for the coil spring of claim 1, the method comprising:
placing a disk-shaped damping element in a casting mold which has a core, with the result that the inside of the damping element is bent over along the core, and the damping element adopts an annular form with a collar on its inside; and
molding or injection-molding an annular receiving element to the damping element, with the result that the bottom side of the receiving element is in contact with the annular damping element.

8. The method of claim 7, wherein the disk-shaped damping element is placed on a bottom element, and the receiving element is placed on the damping element, and the receiving element is then pressed in the direction of the bottom element, with the result that the damping element is fixed between the two other elements.
